(19) United States
(12) Patent Application Publication
(10) Pub. No.: US 2015/0085083 A1
(43) Pub. Date: Mar. 26, 2015

(54) IMAGE-CAPTURING SYSTEM WITH DUAL LENS CAMERA

(71) Applicant: National Central University, Jhongli City (TW)

(72) Inventors: Ching-Han CHEN, Jhongli City (TW); Zi-Hong LI, Jhongli City (TW)

(73) Assignee: National Central University, Jhongli City (TW)

(21) Appl. No.: 14/133,084

(22) Filed: Dec. 18, 2013

(30) Foreign Application Priority Data
Sep. 25, 2013 (TW) 102134594

(51) Int. Cl. H04N 13/02; H04N 5/232

(52) U.S. Cl. CPC H04N 13/0239; H04N 5/23238; H04N 5/23296; H04N 5/23245; H04N 2013/0081
USPC 348/49

(57) ABSTRACT

An image-capturing system with a dual lens camera provided in the present invention includes a first lens, a second lens, an actuating module, a control unit, and an image processing unit. The actuating module is utilized to rotate the first lens and the second lens. The control unit controls the actuating module to rotate the first lens and the second lens such that a first visibility region overlaps a second visibility region to define an overlapping range which has a first mode and a second mode according to a size of the overlapping region. The image processing unit stitches the first image of the first lens and the second image of the second lens for forming an ultra wide-angle image in the first mode; the image processes unit processing the first image and the second image into a stereoscopic image in the second mode.

### CROSS-REFERENCE

This application claims the priority of Taiwan Patent Application No. 102134594, filed on Sep. 25, 2013.

### TECHNICAL FIELD OF THE INVENTION

The present invention relates to an image-capturing system, and especially to an image-capturing system with a dual lens camera.

### BACKGROUND OF THE INVENTION

With the development of technology, a variety of electronic products were made through automation processes. A prior art appearance inspection for the products is performed mainly by using artificial visual inspection. However, reliability of the artificial visual inspection varies, and the quality of the inspection will change with inspector's ability and mental statuses. Therefore, a machine vision has been developed in recent years, thereby replacing the unreliable artificial inspection.

The machine vision is a product developed mainly for the demand of the visual inspections on automated production lines with multi-functions, such as a defect detection of goods quality, an apparent size measurement, a count of workpieces, an identification confirmation, and so on. Users can carry out high-speed, precise, and various inspection functions of the machine vision via an image process controller, so as to solve erroneous recognitions due to the inspector's fatigue or negligence on the production line, or to identify the defects of goods that human eyes are unable to identify, thereby further upgrading the goods quality on the production line, increase production efficiency of equipments, and reducing labor costs.

In recent years, the machine vision has gradually applied in an automobile safety warning system with functions, such as a lane departure warning, a front barrier identification, or a judgment of the vehicle in front being too close, and so on. However, the machine vision utilizing image capture is easy to misjudge indicating lines or traffic signs on the road to be the barriers. Thus, the machine vision requires an ability of distance calculation with depth information in order to prevent the misjudgment. Because of this, the detection range of the existing automobile safety warning system is mostly within a close range. On the other hand, the machine vision can also be utilized as a car video recorder. However, the car video recorder focuses on an ultra wide-angle image capture, but it does not require the function of the distance detection. Thus, lenses which are selected for the both are quite different, and a balance therebetween can not be achieved, still having a shortcoming for the usage.

### SUMMARY OF THE INVENTION

Accordingly, an objective of the present invention is to provide an image-capturing system with a dual lens camera, which has an ultra wide-angle mode and a stereoscopic mode to completely solve the shortcoming that an optimal lens selection for the automobile safety warning system can not be achieved.

Another objective of the present invention is to provide an image-capturing system with a dual lens camera, which can capture a position of an object by the ultra wide-angle mode and then switches to the stereoscopic mode to calculate a distance of the object, thereby providing complete monitoring functions.

To achieve the foregoing objectives, according to an aspect of the present invention, an image-capturing system with a dual lens camera provided in the present invention includes a first lens, a second lens, an actuating module, a control unit, and an image processing unit. The first lens is utilized to capture a first image, and has a first visibility range. The second lens is disposed away from the first lens with a predetermined distance. The second lens is utilized to capture a second image, and has a second visibility range. The actuating module is coupled to the first lens and the second lens, and utilized to rotate the first lens and the second lens. The control unit is electrically coupled to the actuating module, and utilized to control the actuating module to rotate the first lens and the second lens such that the first visibility region overlaps the second visibility region to define an overlapping range which has a first mode and a second mode according to a size of the overlapping region. The image processing unit is electrically coupled to the control unit and receives the first image and the second image. The image processing unit stitches the first image and the second image for forming an ultra wide-angle image in the first mode; the image processing unit processes the first image and the second image into a stereoscopic image in the second mode.

In one preferred embodiment, the overlapping range in the first mode is smaller than the overlapping range in the second mode. Furthermore, the overlapping range in the second mode has a smallest range.

In one preferred embodiment, the first lens and the second lens are disposed on a platform, and the platform is substantially horizontal. In the embodiment, the actuating module comprises a first motor and a second motor, which are respectively coupled to the first lens and the second lens for respectively rotating the first lens and the second lens. Preferably, the first motor and the second motor are stepper motors. Moreover, the actuating module further includes a gyroscopes and/or an accelerometer for keeping the platform horizontal.

To achieve the another objective mentioned above, the present invention provides an image-capturing system for measuring a position and a distance of an object relative to the system. The system includes a first lens, a second lens, an actuating module, a control unit, and an image processing unit. The first lens is utilized to capture a first image, and has a first visibility range. The second lens is disposed away from the first lens with a predetermined distance. The second lens is utilized to capture a second image, and has a second visibility range. The actuating module is coupled to the first lens and the second lens, and utilized to rotate the first lens and the second lens, so that the object is within the first image and/or the second image. The control unit is electrically coupled to the actuating module, and utilized to control the actuating module to rotate the first lens and the second lens such that the first visibility region overlaps the second visibility region to define an overlapping range which has a first mode and a second mode according to a size of the overlapping region. The image processing unit is electrically coupled to the control unit and receives the first image and the second image. The image processing unit stitches the first image and the second image for forming an ultra wide-angle image in the first mode, and obtains the position of the object relative to the system. The image processing unit processes the first image and the second image into a stereoscopic image in the second mode, and calculates the distance of the object relative to the system.

In the embodiment, the overlapping range in the first mode is smaller than the overlapping range in the second mode. Moreover, the object is located at the overlapping range in the second mode.

In comparison with the prior art, the present invention employs the two lenses being capable of rotating by the control unit, so as to simultaneously have the ultra wide-angle mode and the stereoscopic mode; thus, the shortcoming that an optimal lens selection for the automobile safety warning system can not be achieved is completely solved. In addition, by means of the control unit controlling the rotation of the two lenses, the position of the object can firstly be found out by the ultra wide-angle mode, and secondly, the distance of the object can be determined by the stereoscopic mode, in order to provide an intelligent monitor function.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 depicts a functional block diagram illustrating an image-capturing system with a dual lens camera of a first preferred embodiment of the present invention;

FIG. 2 depicts a top view schematically illustrating the image-capturing system with a dual lens camera of the embodiment;

FIG. 3 depicts a top view schematically illustrating the image-capturing system with a dual lens camera of the first embodiment in the first mode;

FIG. 4 depicts a top view schematically illustrating the image-capturing system with a dual lens camera of the first embodiment in the second mode;

FIG. 5 depicts a functional block diagram illustrating the image-capturing system of the second embodiment of the present invention monitoring an object;

FIG. 6 depicts a top view schematically illustrating the image-capturing system with a dual lens camera of the second embodiment in the first mode; and

FIG. 7 depicts a top view schematically illustrating the image-capturing system with a dual lens camera of the second embodiment in the second mode.

### DETAILED DESCRIPTION OF THE INVENTION

The present invention will now be described in detail with reference to a few preferred embodiments thereof as illustrated in the accompanying drawings. The same reference numerals refer to the same parts or like parts throughout the various figures.

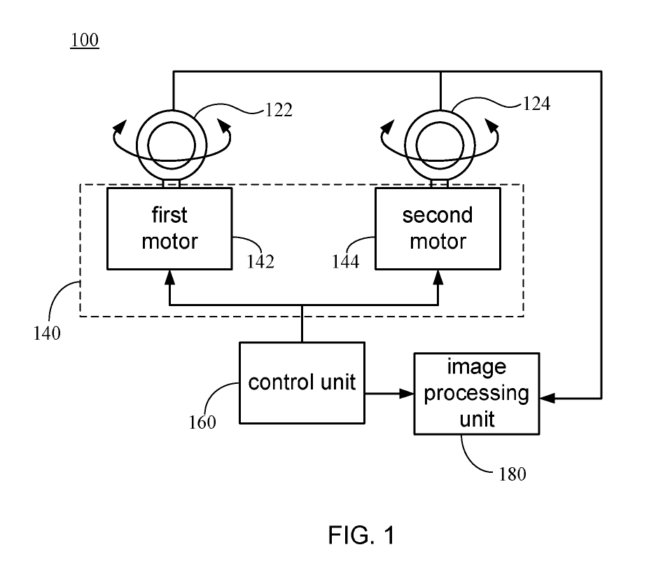

The image-capturing system with a dual lens camera of the present invention is not limited to the applications of the automobile safety warning system and the car video recorder. Others, such as machine vision of a robot, a security monitoring system, and the goods inspection on the production line, and so on, are within the scope of the present invention. Referring to FIG. 1, FIG. 1 depicts a functional block diagram illustrating an image-capturing system with a dual lens camera of a first preferred embodiment of the present invention. The image-capturing system 100 with a dual lens camera of the embodiment includes a first lens 122, a second lens 124, an actuating module 140, a control unit 160, and an image processing unit 180.

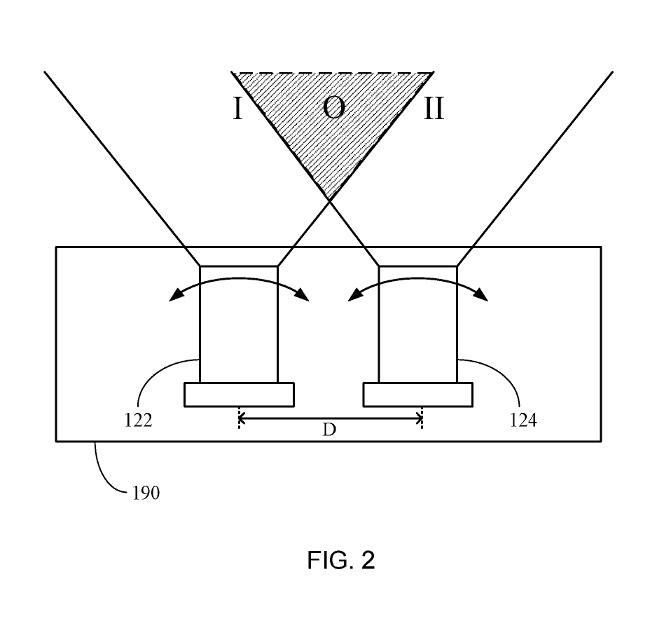

Referring to FIG. 1 and FIG. 2, FIG. 2 depicts a top view schematically illustrating the image-capturing system with a dual lens camera of the embodiment. The first lens 122, otherwise known as a left lens, is utilized to capture a first image (not shown), and the first lens 122 has a first visibility range I, i.e. a range within a visual angle of the first lens 122. The second lens 124, otherwise known as a right lens, is disposed away from the first lens 122 with a predetermined distance D. The second lens 124 utilized to capture a second image (not shown), and has a second visibility range II, i.e. a range within a visual angle of the second lens 124.

In the embodiment, the first lens 122 and the second lens 124 employ the same lens; that is, they have the same visual angle and performance. More specifically, the first lens 122 and the second lens 124 can be Charge-coupled Device (CCD) cameras or Complementary Metal-Oxide Semiconductor (CMOS) cameras. In the embodiment, the first lens 122 and second lens 124 are disposed on a platform 190, and the platform 190 is substantially horizontal. Preferably, the platform 190 is a printed circuit board (PCB), and the above-mentioned control unit 160 and image processing unit 180 can be disposed on the printed circuit board.

As shown in FIG. 1, the actuating module 140 is coupled to the first lens 122 and the second lens 124, and the actuating module 140 is utilized to rotate the first lens 122 and the second lens 124, i.e. to change shooting angles of the first lens 122 and the second lens 124. In the embodiment, the actuating module 140 includes a first motor 142 and a second motor 144, which are respectively coupled to the first lens 122 and the second lens 124 for respectively rotating the first lens 122 and the second lens 124. Specifically, the first motor 142 and the second motor 144 are stepper motors, both of which are used for precisely controlling angles of rotation of the first lens 122 and the second lens 124.

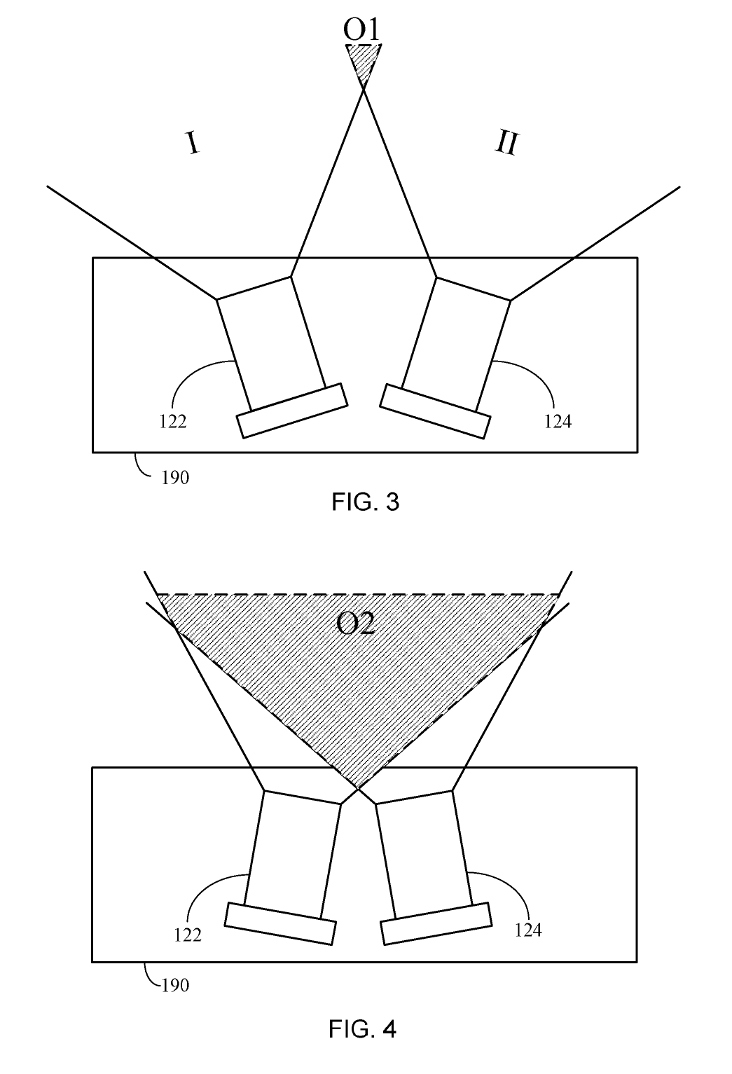

Referring to FIG. 1 and FIG. 2, the control unit 160 is electrically coupled to the actuating module 140, and utilized to control the actuating module 140 to rotate the first lens 122 and the second lens 124 such that the first visibility region I overlaps the second visibility region II to define an overlapping range 0, which has a first mode and a second mode according to the size of the overlapping region 0. The following will explain the above-mentioned modes in detail with FIGS. 3 and 4.

FIG. 3 depicts a top view schematically illustrating the image-capturing system with a dual lens camera of the first embodiment in the first mode; FIG. 4 depicts a top view schematically illustrating the image-capturing system with a dual lens camera of the first embodiment in the second mode. Referring to FIG. 3 and FIG. 4, in the preferred embodiment, the overlapping range O1 in the first mode (FIG. 3) is smaller than the overlapping range O2 in the second mode (FIG. 4). Referring to FIG. 1, the image processing unit 180 is electrically coupled to the control unit 160 and receives the first image and the second image.

In the first mode, the image processing unit 180 stitches the first image and the second image for forming an ultra wide-angle image. That is to say, the image processing unit 180 compares overlapping portions (i.e. part of the image within the overlapping range O1) of the first image and the second image, and thus it has a foundation for aligning the two images. Subsequently, it stitches the two images from their overlapping portions, so as to form an ultra wide-angle image. It is worth mentioning that the angles of the outward rotation of the first lens 122 and the second lens 124 can be controlled via the control unit 160. When the overlapping range O1 of the shooting angles with the rotation reaches a critical edge, the widest ultra wide-angle image is available. Meanwhile, the overlapping range O1 in the second mode has a smallest range. Accordingly, the first lens 122 and the second lens 124 need not employ the ultra wide-angle lenses, or even fish-eye lenses, thereby avoiding the problem of image distortion.

In the second mode, the image processing unit 180 processes the first image and the second image into a stereoscopic image. Specifically, in order to calculate the depth information of the object by the image processing unit 180, the object must be located at the overlapping range O2 for simultaneously appearing in the first image and the second image.

Under this condition, the depth information of the object can be calculated through algorithms.

It is worth mentioning that because when the first lens 122 and the second lens 124 are not positioned on a same horizontal plane, the image processing unit 180 needs to perform horizontal and vertical calibrations for the first image and the second image correction during processing the stereoscopic image. Thus, there is a problem of a heavy computational load. Accordingly, the actuating module 160 of the image-capturing system 100 of the embodiment further includes a gyroscopes and/or an accelerometer, which are utilized to keep the platform 190 horizontal, so as to improve the efficiency of the image processing unit 180 processing the stereoscopic image. That is to say, the actuating module 160 can further includes a triaxial motor (not shown) for keeping the platform 190 horizontal. However, except for the gyroscopes and the accelerometer, the actuating module 160 can further includes a magnetometer for improving the sensing of position.

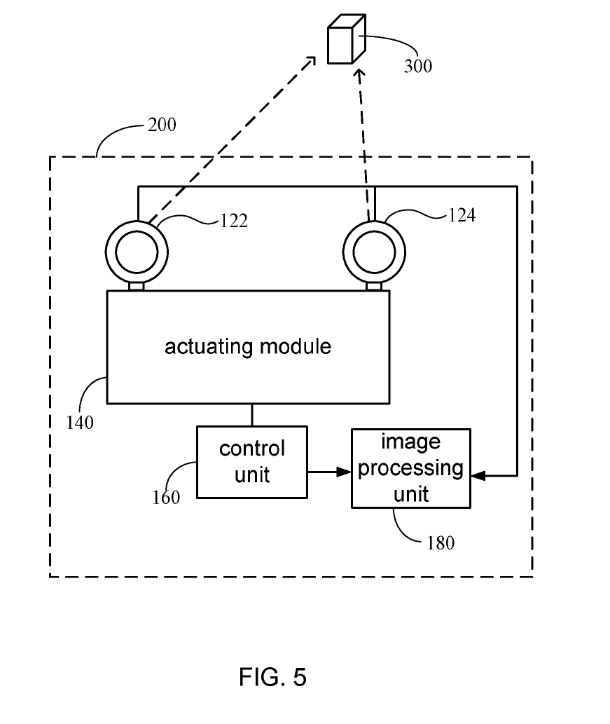

The image-capturing system of a second embodiment of the present invention will be explained in the following. Referring to FIG. 5, FIG. 5 depicts a functional block diagram illustrating the image-capturing system of the second embodiment of the present invention monitoring an object. The image-capturing system 200 of the second embodiment can be utilized to measure a position and a distance of the object 300 relative to the system 200. Similarly, the image-capturing system 200 includes a first lens 122, a second lens 124, an actuating module 140, a control unit, 160 and an image processing unit 180. Amongst these elements, the descriptions of the elements similar to the first embodiment have been explained as above mention, so we need not go into detail herein.

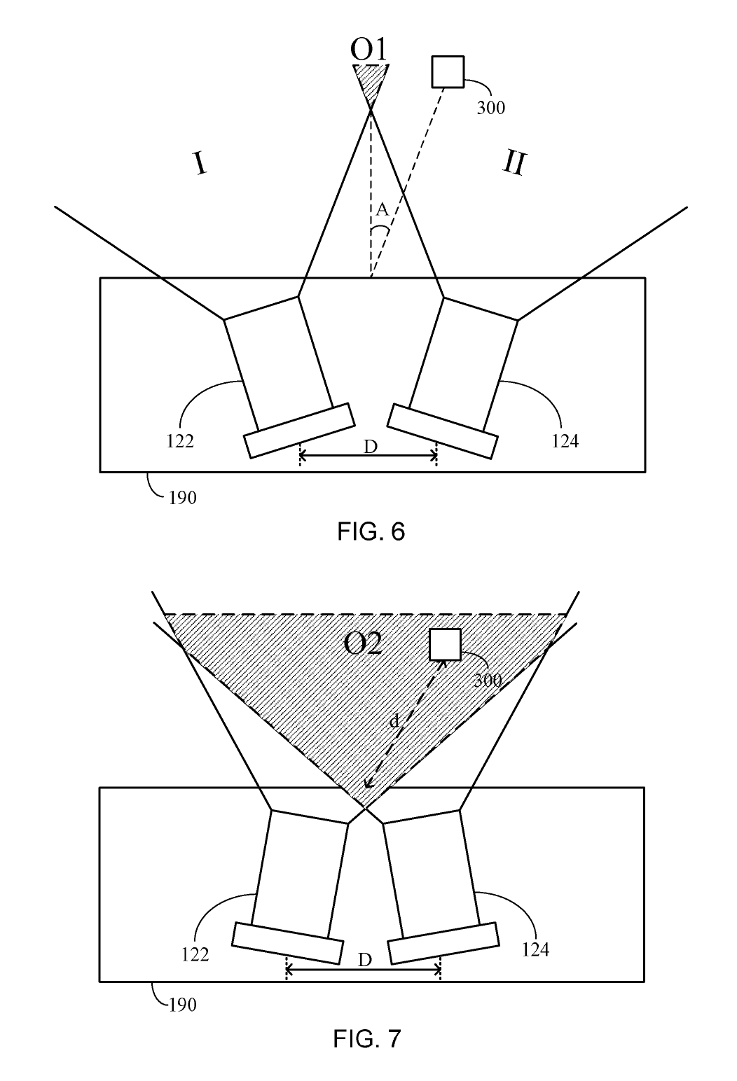

Referring to FIG. 6 and FIG. 7, FIG. 6 depicts a top view schematically illustrating the image-capturing system with a dual lens camera of the second embodiment in the first mode; FIG. 7 depicts a top view schematically illustrating the image-capturing system with a dual lens camera of the second embodiment in the second mode. The first lens 122 is utilized to capture a first image, and has a first visibility range I. The second lens 124 is disposed away from the first lens 122 with a predetermined distance D, and utilized to capture a second image. The second lens 124 has a second visibility range II.

As shown in FIGS. 5-7, the actuating module 140 is coupled to the first lens 122 and the second lens 124, and the actuating module 140 is utilized to rotate the first lens 122 and the second lens 124, so that the object 300 is within the first image and/or the second image.

Similarly, the control unit 160 is electrically coupled to the actuating module 140, and utilized to control the actuating module 140 to rotate the first lens 122 and the second lens 124 such that the first visibility region I overlaps the second visibility region II to define an overlapping range O, which has a first mode and a second mode according to the size of the overlapping region O.

The image processing unit 180 is electrically coupled to the control unit 160 and receives the first image and the second image. In the first mode, the image processing unit 180 stitches the first image and the second image for forming an ultra wide-angle image, and obtaining the position, i.e. an azimuth A of the object 300 relative to the system 200. In the second mode, the image processing unit 180 processes the first image and the second image into a stereoscopic image, and calculates the distance d of the object 300 relative to the system 200. As mentioned above, the overlapping range O1 in the first mode is smaller than the overlapping range O2 in the second mode.

Specifically, the processes with regard to the image-capturing system 200 of the second preferred embodiment monitoring the object 300 will be described in the following. The image-capturing system 200 is firstly in the ultra wide-angle mode, i.e. a searching mode as shown in FIG. 6. That is, the actuating module 140 rotates the first lens 122 and the second lens 124, or rotates the whole platform 190. When the object 300 is found on the first image and/or the second image, the first lens 122 and the second lens 124 are rotated inwardly to switch to the stereoscopic mode as shown in FIG. 7. Meanwhile, the object 300 is positioned at the overlapping range O2 in the second mode, and then the distance d of the object 300 can be calculated via algorithms.

In summary, the present invention employs the two lenses 122 and 124 being capable of rotating by the control unit, so as to simultaneously have the ultra wide-angle mode and the stereoscopic mode; thus, the shortcoming that an optimal lens selection for the automobile safety warning system can not be achieved is completely solved. In addition, by means of the control unit 160 controlling the rotation of the two lenses 122 and 124, the position of the object 300 can firstly be found out by the ultra wide-angle mode, and secondly, the distance d of the object 300 can be determined by the stereoscopic mode, in order to provide an intelligent monitor function.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. An image-capturing system with a dual lens camera, comprising:
a first lens utilized to capture a first image, the first lens having a first visibility range;
a second lens disposed away from the first lens with a predetermined distance, utilized to capture a second image, the second lens having a second visibility range;
an actuating module coupled to the first lens and the second lens, utilized to rotate the first lens and the second lens;
a control unit electrically coupled to the actuating module, utilized to control the actuating module to rotate the first lens and the second lens such that the first visibility region overlaps the second visibility region to define an overlapping range having a first mode and a second mode according to a size of the overlapping region; and
an image processing unit electrically coupled to the control unit and receiving the first image and the second image, the image processing unit stitching the first image and the second image for forming an ultra wide-angle image in the first mode; the image processing unit processing the first image and the second image into a stereoscopic image in the second mode.

2. The image-capturing system of claim 1, wherein the overlapping range in the first mode is smaller than the overlapping range in the second mode.

3. The image-capturing system of claim 2, wherein the overlapping range in the second mode has a smallest range.

4. The image-capturing system of claim 1, wherein the first lens and the second lens are disposed on a platform, and the platform is substantially horizontal.

5. The image-capturing system of claim 4, wherein the actuating module comprises a first motor and a second motor, which are respectively coupled to the first lens and the second lens for respectively rotating the first lens and the second lens.

6. The image-capturing system of claim 5, wherein the first motor and the second motor are stepper motors.

7. The image-capturing system of claim 5, wherein the actuating module further comprises a gyroscopes and/or an accelerometer for keeping the platform horizontal.

8. An image-capturing system with a dual lens camera for measuring a position and a distance of an object relative to the system, the system comprising:
a first lens utilized to capture a first image, the first lens having a first visibility range;
a second lens disposed away from the first lens with a predetermined distance, utilized to capture a second image, the second lens having a second visibility range;
an actuating module coupled to the first lens and the second lens, utilized to rotate the first lens and the second lens, so that the object is within the first image and/or the second image;
a control unit electrically coupled to the actuating module, utilized to control the actuating module to rotate the first lens and the second lens such that the first visibility region overlaps the second visibility region to define an overlapping range having a first mode and a second mode according to a size of the overlapping region; and
an image processing unit electrically coupled to the control unit and receiving the first image and the second image, the image processing unit stitching the first image and the second image for forming an ultra wide-angle image in the first mode, and obtaining the position of the object relative to the system; the image processing unit processing the first image and the second image into a stereoscopic image in the second mode, and calculating the distance of the object relative to the system.

9. The image-capturing system of claim 8, wherein the overlapping range in the first mode is smaller than the overlapping range in the second mode.

10. The image-capturing system of claim 9, wherein the object is located at the overlapping range in the second mode.

11. The image-capturing system of claim 8, wherein the first lens and the second lens are disposed on a platform, and the platform is substantially horizontal.

12. The image-capturing system of claim 11, wherein the actuating module comprises a first motor and a second motor, which are respectively coupled to the first lens and the second lens for respectively rotating the first lens and the second lens.

13. The image-capturing system of claim 12, wherein the first motor and the second motor are stepper motors.

14. The image-capturing system of claim 12, wherein the actuating module further comprises a gyroscopes and/or an accelerometer for keeping the platform horizontal.
